(19) United States
(12) Patent Application Publication
(10) Pub. No.: US 2002/0133471 A1
(43) Pub. Date: Sep. 19, 2002

(54) Configuration enablement of franking system

(76) Inventors: Fetneh Eskandari, Middletown, CT (US); Peter Stutz, Hinterkappelen (CH)

Correspondence Address: PERMAN & GREEN, 425 POST ROAD, FAIRFIELD, CT, 06430, US

(21) Appl. No.: 10/081,316

(22) Filed: Feb. 21, 2002

Related U.S. Application Data
(60) Provisional application No. 60/270,796, filed on Feb. 23, 2001.
(60) Provisional application No. 60/277,806, filed on Mar. 22, 2001.
(60) Provisional application No. 60/277,841, filed on Mar. 22, 2001.
(60) Provisional application No. 60/277,873, filed on Mar. 22, 2001.
(60) Provisional application No. 60/277,931, filed on Mar. 22, 2001.
(60) Provisional application No. 60/277,946, filed on Mar. 22, 2001.
(60) Provisional application No. 60/338,892, filed on Nov. 5, 2001.

(51) Int. Cl. G07B 17/02

(52) U.S. Cl. 705/401; 705/402

(57) ABSTRACT

A method and system for customizing a computerized system having a plurality of operating features, including selecting at least one independent parameter from a predefined list of parameters for selecting at least one of the operating features of the customized computerized system, and storing the independent parameter in a parameter set. The at least one of the selected operating features is enabled by selecting at least one secondary parameter from a predefined list of secondary parameters, wherein the secondary parameter are associated with the at least one independent parameter, and at least one secondary parameter is stored in the parameter set. At least one dependent parameter is determined for configuring the computerized system, wherein the dependent parameter is generated from a predefined list of dependent parameters in accordance with the parameter set, and the dependent parameter is added to the parameter set. A compilation of parameters is installed in the customized computerized system, where the compilation of parameters is generated from the parameter set, wherein the compilation of parameters enables the selected operating features of the customized computerized system.

### CROSS REFERENCE TO RELATED APPLICATIONS

This application claims priority of the following U.S. provisional patent applications:

Ser. No. 60/270,796 filed on Feb. 23, 2001,

Ser. No. 60/277,806 filed on Mar. 22, 2001,

Ser. No. 60/277,841 filed on Mar. 22, 2001,

Ser. No. 60/277,873 filed on Mar. 22, 2001,

Ser. No. 60/277,931 filed on Mar. 22, 2001,

Ser. No. 60/277,946 filed on Mar. 22, 2001, and

Ser. No. 60/338,892 filed on Nov. 5, 2001.

### BACKGROUND OF THE INVENTION

1. Field of the Invention

The present invention relates to a system for customizing a computerized system and, more particularly, a system for ordering, customizing and installing a franking system.

2. Brief Description of Related Developments

Franking systems can have a number of different configurations of operating features. For instance, a franking system could be used with an operating feature such as a dynamic scale for measuring the weight of a mailpiece, a static scale, or without any type of scale. A franking system could also be used with an operating feature such as one of a number of letter flow speeds. Usually, the franking systems used with more features and faster features are more expensive.

For a franking system manufacturer, it can be very costly to produce a number of different versions of franking systems with different operating features. Furthermore, keeping inventory which includes different versions of the franking system is costly for a franking system distributor or sales organization.

Furthermore, a franking system installation can be very time consuming and costly For instance, a representative from the franking system sales organization, franking system distributor or franking system manufacturer may have to visit the customer's site to install the operating features selected by the customer. The representative may also be required to visit the customer's site or upgrade the franking system by adding operating features selected by the customer, or there may be the need to send out additional hardware or software. During an upgrade, the selected operating features often include both hardware and software, which can require a significant amount of time from the franking system representative for installation and integration with the existing operating features.

Furthermore, the franking system representative often wants to prevent the addition of unauthorized equipment to the franking system. Unauthorized equipment may interfere with the other operating features of the franking system, which a franking system representative may have to fix. Moreover, the quality of the unauthorized equipment may be inferior to a franking system authorized equipment. The franking system representative may also wish to ensure that they receive any revenue associated with installing or adding additional equipment or operating features to the franking system. Customers and potential customers should not be able to use franking system equipment or operating features for which they have not paid.

It would be advantageous to have a franking system and method for installation and upgrading which could overcome the disadvantages of the existing franking systems.

### SUMMARY OF THE INVENTION

The present invention is directed to a method for customizing a computerized system having a plurality of operating features. In one embodiment, the method includes selecting at least one independent parameter from a predefined list of parameters for selecting at least one of the operating features of the customized computerized system, and storing the independent parameter in a parameter set. The method further includes enabling the at least one of the selected operating features by selecting at least one secondary parameter from a predefined list of secondary parameters, wherein the secondary parameters are associated with the selected at least one independent parameter, and storing the at least one secondary parameter in the parameter set.

The method also includes determining at least one dependent parameter for configuring the computerized system, wherein the dependent parameter is generated from a predefined list of dependent parameters in accordance with the parameter set, and adding the dependent parameter to the parameter set. Moreover, the method includes installing a compilation of parameters in the customized computerized system, the compilation of parameters generated from the parameter set, wherein the compilation of parameters enable the selected operating features of the customized computerized system.

In one aspect, the present invention is directed to a method for customizing a franking system. In one embodiment, the method comprises providing a franking system having a plurality of disabled operating features, and selecting at least one of the plurality of disabled operating features from the plurality of disabled operating features for enabling for use in the franking system. The method also includes storing the at least one of the selected disabled operating features in a parameter set, generating an authorization code based on the parameter set for enabling the selected disabled operating features of the franking system, and entering the authorization code into the franking system wherein each of the selected disabled operating features are enabled.

In another aspect, the present invention is directed to a production system for generating a customized computerized system having a plurality of flexible operating features. In one embodiment, the production system includes a customer sheet system for recording the selection of an operating feature from a group of predefined operating features, and for generating at least one independent parameter, and a parameter set for storing the at least one independent parameter. A manufacturer parameter system provides at least one secondary parameter associated with the at least one independent parameter for implementing the selected operating feature, and stores the at least one secondary parameter in the parameter set.

A configuration parameter system generates at least one dependent parameter based on the independent parameter and the secondary parameter for configuring the customized computerized system, and adds the at least one dependent parameter to the parameter set. An input device enters a compilation of parameters in the customized computerized system for configuring the customized computerized system, where the compilation of parameters is generated from the parameter set by the configuration parameter system.

In a further aspect, the present invention is directed to a method of exchanging a primary computerized system having enabled and disabled operating features for a secondary computerized system having identical enabled and disabled operating features. In one embodiment, the method includes accessing customization parameters of the primary computerized system which define the enabled and the disabled operating features of the primary computerized system, and storing the customization parameters for preserving the enabled and disabled operating features of the primary computerized system. The method also includes installing the customization parameters in a second computerized system for duplicating the enabled and disabled operating features of the primary computerized system in the second computerized system by loading the stored customization parameters into the second computerized system.

In another aspect, the present invention is directed to a method for enabling an additional operating feature of a franking system. In one embodiment, the method includes providing a franking system having at least one disabled operating feature, and at least one operating feature which is enabled and available for use, and selecting the new operating feature for adding to the franking system from the at least one disabled operating feature. The method further includes generating an authorization code associated with the enabled operating features and the selected disabled operating feature for enabling the selected disabled operating feature and the enabled operating features, and entering the authorization code into the franking system for enabling the selected disabled operating feature and the enabled operating features.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a franking system incorporating features of the present invention.

FIG. 2 is an illustration of one embodiment of a franking system incorporating features of the present invention.

FIG. 3 is a block diagram of one embodiment of a system of the present invention for configuring a customized computerized system.

FIG. 4 is a flowchart of one embodiment of a system of the present invention for configuring a customized computerized system.

FIG. 5 is a block diagram of one embodiment of the present invention for configuring a second computerized system.

### DETAILED DESCRIPTION OF THE PREFERRED EMBODIMENT(s)

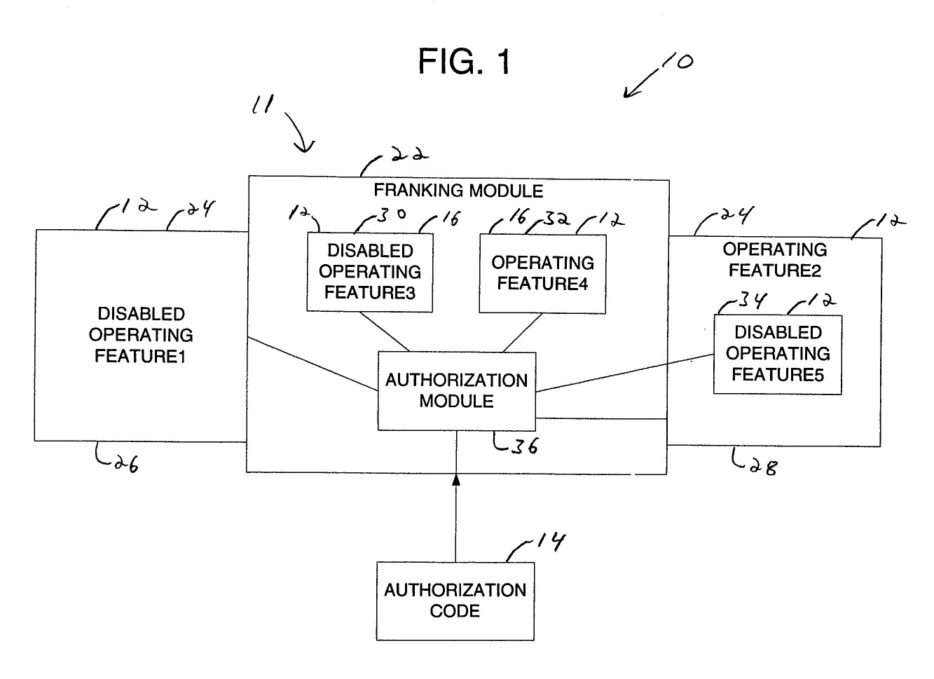

Referring to FIG. 1, there is shown a block diagram of a system 10 incorporating features of the present invention. Although the present invention will be described with reference to the embodiment shown in the drawings, it should be understood that the present invention can be embodied in many alternate forms of embodiments. In addition, any suitable size, shape or type of elements or materials could be used.

As shown in FIG. 1, in one embodiment the system 10 generally comprises a franking system 11 having a franking module 22 and including all variants of behavior into each franking system 11, such as a plurality of operating features 12 of the franking system 11. The franking system 11 can include operating features 12 which are not be enabled for use. The franking system 11 can be configured and the operating features 12 can be enabled and/or disabled by the entry of an authorization code 14. The operating features 12 enabled and disabled by the new authorization code 14 take effect after the input of the authorization code 14 and the restart of the franking system 11.

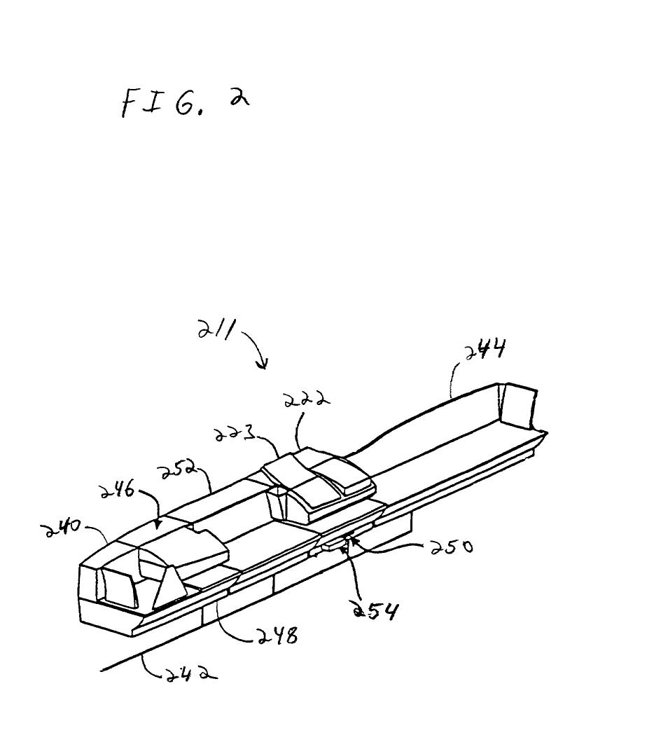

Referring to FIGS. 1 and 2, the authorization code can be generated based on the operating features 12 selected by the customer. Other inputs to the generation of the authorization code 14 can be a unique identifying feature, such as a serial number or group of serial numbers or part numbers, associated with the franking module. Further inputs to the generation of the authorization code can include other identifying features, or groups of identifying features, such as a software part number, a software serial number, a software version number, a rate table name, a rate table version, a postal security device (PSD) number, or any other unique reference or combination of references associated with the franking system 11.

Continuing with FIGS. 1 and 2, the software and rate package part numbers and serial numbers can be located in the back (not shown) of the franking module 22. While the back of the franking module 22 has been described as the location of the part numbers and serial numbers, the present invention is not so limited, as the part numbers and serial numbers can be located anyplace they are accessible during the creation of the authorization code 14, including separate from the franking system 11, without departing from the broader aspects of the present invention.

Only an authorization code 14 which includes the unique reference of the particular franking system 11 is able to enable the operating features 12 of the particular franking system 11. If a correct authorization code 14 is not entered, the franking system 11 will not be operational. An authorization code 14 can be linked to a specific franking system 11, and enable operating features only in that specific franking system 11 with the identifying features used in generating the authorization code. Furthermore, the authorization code 14 which enables the operating features 12 of one franking system 11 will not enable the operating features of another franking system 11, will not allow the use of an unauthorized copy of a rate table, and will not allow the use of an unauthorized PSD on the franking system 11. Only software and hardware corresponding to the identifying features which were used to generate the authorization code can be used in the franking system 11.

Moreover, the franking system manufacturer can produce the franking system 11 with a plurality of independent operating features 12 and distribute the franking system 11 from a factory to a distributor, dealer and customer. With the use of the authorization code 14 to enable and disable the operating features 12 of the franking system 11, the franking system 11 can be upgraded or downgraded at any point in the distribution chain without providing additional hardware or software for the franking system

Referring to FIG. 1, in general, the franking system 11 comprises a device for printing postage on letters. In an alternate embodiment, the franking system 11 can comprise any suitable device for providing a postal indicium on a mailpiece. Furthermore, the franking system 11 is a modular device in that the franking system 11 is designed so that operating features can optionally be added or removed from the franking system 11. Further information which may be of interest regarding a modular franking system is included in U.S. patent application Ser. No. ______, filed on ______, entitled “Modular Franking System” for Moy, Fluckiger and Stutz, which is incorporated herein by reference.

Referring to FIGS. 1 and 2, in one embodiment, the franking system 11 can include an input device 223, and operating features 12, such as peripheral devices 24 and software systems 16. The input device 223 can include a touch screen, a keyboard and a main computer for entering or updating system data, such as entering an authorization code. Other input devices 223 can include a microphone, a CD or a DVD reader, other storage device readers, a scanner, and data input, including voice, audio and visual input, such as network, internet and intranet, without departing from the broader aspects of the present invention.

Each peripheral device 24 shown in FIG. 1 generally comprises a device for implementing letter flow through the franking system 11. Referring to FIG. 2, other peripheral devices which can be attached to the franking system 211 can include a bus system 242 for connecting peripheral devices to a franking module 222, a static weighing scale 246, a stand 248 for the static weighing scale 246, the rate package card 250, and a dynamic scale 252 for determining an accurate weight of mail pieces to calculate the different postage to be applied. The franking system can also include the postal security device 254 which includes postage data and postal statistics data.

Further information regarding letter handling peripheral devices 24 which may be of interest is included in U.S. patent application Ser. No. ______, filed on ______, entitled “Letter Flow Controls” for Moy, Stutz and Jaeger, which is incorporated herein by reference. Further information which may be of interest regarding a feeder/sealer device 240 is included in U.S. patent application Ser. No. , filed on ______, entitled “Separator” for Jaeger, Etter and Gasser, and U.S. Pat. No. ______, filed on ______, entitled “Letter Moistener” for Saurer, Etter and Gasser, which applications are incorporated herein by reference. Further information which may be of interest regarding a stacker 244 is included in U.S. patent application Ser. No. filed on ______, entitled “Stacker” for Jaeger, Etter and Gasser, which is incorporated herein by reference.

Referring to FIGS. 1 and 2, the franking system 11 can include disabled operating feature1 26 and operating feature2 28 as peripheral devices 24, such as the static scale 246 and the dynamic scales 252, respectively. Disabled operating feature3 30 can be a software system module included in the franking module 22, such as a type of accounting system 30 for compiling accounting statistics. For example, one type of accounting system 30 can compile only totals for all mailings, while another type of accounting system 30 can also subtotal by departments and class of mailings, such as first class and second class.

Referring to FIG. 1, operating feature4 32 can be a rate package 32 included in the franking module 22 which can determine limits of a geographic range of the franking system for applying rates, respectively. For instance, one rate package may provide rates only for the U.S., another rate package may provide rates for U.S. and international mailings, while a third rate package may supply rates for U.S. International, UPS™ and Fed Ex™ mailings. Disabled operating feature5 34 can be a software system included in the operating feature2 28, such as a letter flow speed selection. Some peripheral devices 24 are mechanically integrated into the franking system 11 and include software systems for integration with and communicating with the rest of the franking system 11. Such software is integrated into the franking system 11.

Continuing to refer to FIG. 1, the franking module 22 includes an authorization module 36 which employs the authorization code 14 as input to enable and disable operating features 12 of the franking system 11. For instance, operating feature1 26 has been disabled by the entry of the authorization code 14, while operating feature2 28 has been enabled by the entry of the authorization code 14. Similarly, operating feature3 30 and operating feature5 34 have been disabled by the entry of the authorization code, while operating feature4 32 has been enabled.

The operating features 12 of the franking system 11 can also include carrier specific operating features required by the postal service and/or carrier of a particular country for which the franking system will be functioning. Each carrier can have specific standards as to the type of data statistics to be compiled, and the tracking and storage of postal carrier payments. The franking system 11 is required to satisfy the carrier's standards to be placed in operation with that carrier.

Referring to FIGS. 1 and 2, in one embodiment, the franking system manufacturer can assemble a specific model of franking system 11 having operating features customized to each country's carriers. For instance, countries require the use of the postal security device (PSD) 254 for storing carrier data. These franking systems 11 can then be installed for use with a specific country.

Referring to FIGS. 1, 3 and 4, one embodiment of the present invention can be a production system 310 for generating a customized computerized system 311. The production system 310 can include a customer sheet system 356 for recording the operating features 12 selected by a customer. For example, the selected operating feature 12 can include the type of accounting system 30. The sheet system 356 uses the selected operating feature 12 to generate at least one independent parameter 470 representing the selected operating feature 12. The independent parameter 470 is added to a parameter set 358.

Continuing with FIGS. 1, 3 and 4, in one embodiment, the customer sheet system 365 can be a computerized form located on, for example, a web page on a web site or other computer network, which is filled out by a customer or franking system representative, such as a salesperson. In another embodiment, the customer sheet system 365 can be a form, such as a spreadsheet on a computer, or even a paper form, which is filled out and transmitted via carrier, email, facsimile or other means to the franking system representative, such as a distributor or franking system manufacturer.

Referring to FIGS. 1, 3 and 4, the production system 310 also can include a manufacturer parameter system 360 for selecting secondary parameters 472 from a predefined list of secondary parameters 474 which are associated with the previously selected independent parameter 470. Secondary parameters 472 can be other operating features 12 which are added to the parameter set 358 in order to implement the customer's selected operating features 12. For example, the customer can select a static scale mode of weighing on the dynamic scale 252 as an independent parameter 470, but may not select the dynamic scale itself 252. In order to implement the operating functions 12 of the static scale mode, the manufacturer parameter system 360 can select the static scale 252 from the predefined list of secondary parameters 474 for the static scale mode as a secondary parameter 472. The secondary parameter 472 can be added to the parameter set 358.

In one embodiment, the secondary parameter 474 can include a default parameter. The default parameter is a secondary parameter 474 which has not been explicitly selected by the customer but which is required for enabling the selected operating features 12 of the franking system 11. For example, the customer can select a differential weighing mode as an operating feature 12. In order to enable the differential weighing mode, connectivity of the static scale 246 is required. Therefore, at least one of the default parameters for differential weighing is the connectivity of the static scale 246. As a default parameter, the connectivity of the static scale is selected as a secondary parameter 472 from the predefined list of secondary parameters 474 by the manufacturer parameter system 360, and added to the parameter set 358, 458.

Continuing to refer to FIGS. 1, 3 and 4, the manufacturer parameter system 360 examines each independent parameter 470 in the parameter set 358, 458 to determine if one or more secondary parameters 472 are to be added to the parameter set 358, 458. The independent parameter 470 is used to determine whether there are associated secondary parameters 472 which are needed to implement the operating feature 12 associated with the independent parameter 470.

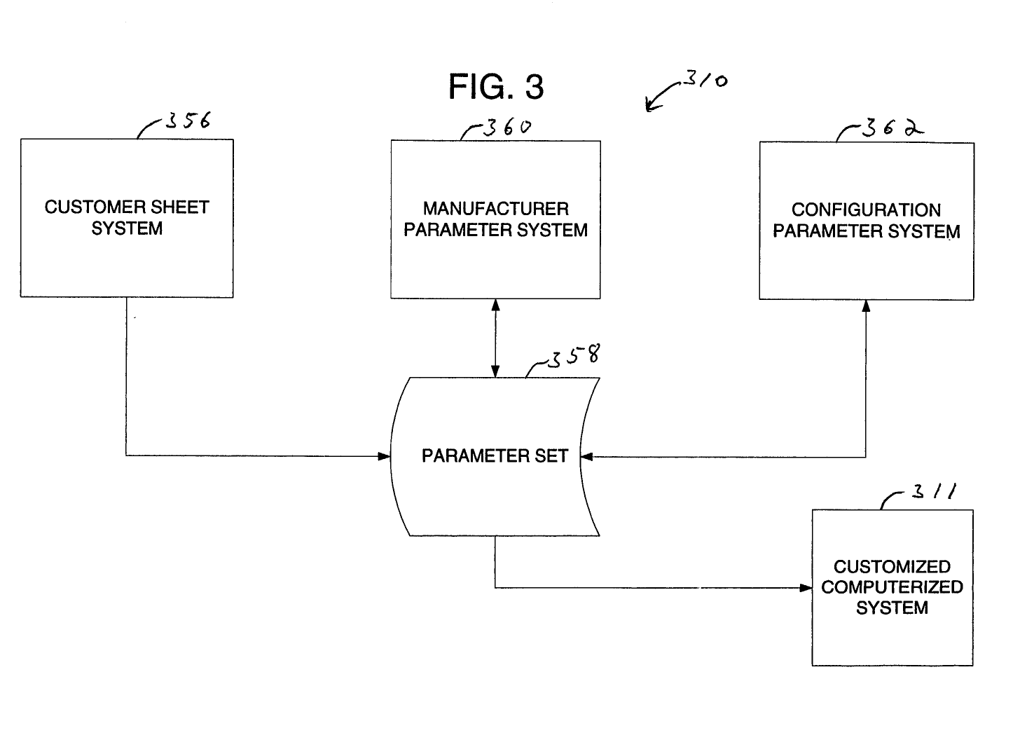

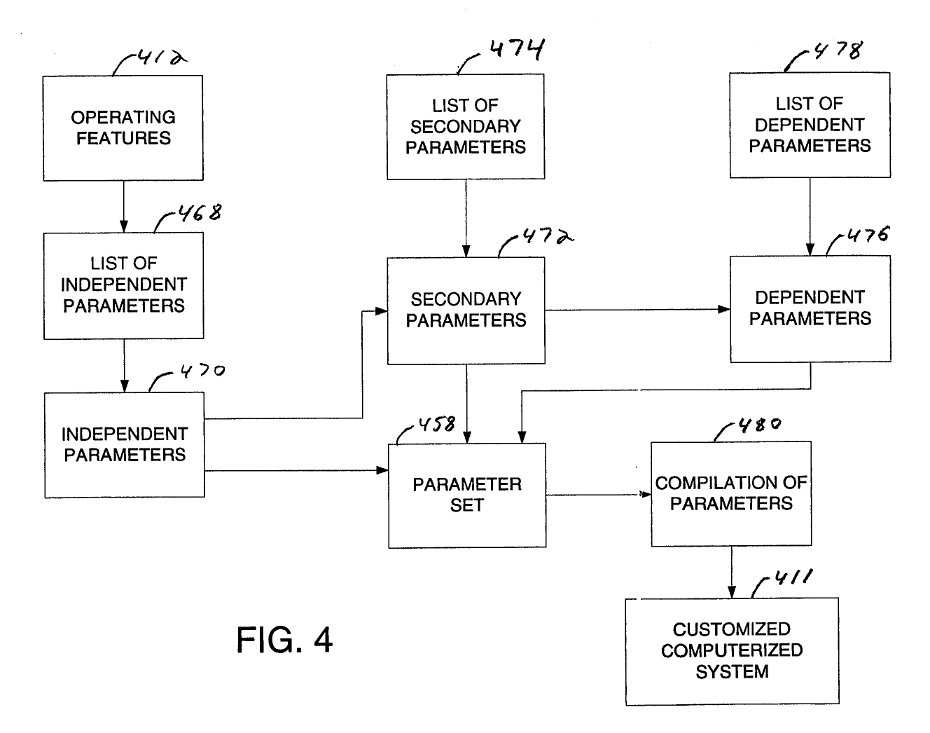

Referring to FIGS. 3 and 4, in one embodiment, the selected secondary parameter 472 can be entered into a computer system or network, such as the internet, and stored in the parameter set 358, 458. In another embodiment, the secondary parameter 472, or secondary parameters 472, can be automatically selected from the predefined list of secondary parameters 474 by a computer system using as input the previously generated independent parameters 470. The selected secondary parameter 472 can be stored in the parameter set 358, 458.

As shown in FIGS. 1, 3 and 4, the production system 310 further includes a configuration parameter system 362 for generating any other parameters 476, such as a dependent parameter 476, which are necessary for the implementing the operating features 412 associated with the independent parameters 470 and secondary parameters 472 in the parameter set 358, 458. The dependent parameter 476 is not necessarily an operating feature 12, but instead can be hardware and/or software, which is necessary for enabling the selected operating features. For example, if a particular rate package 32 is selected, and the associated independent parameter 470 is added to the parameter set 358, a software module, such as for calculating a particular rate, can also be enabled in order to enable the selected rate package. The dependent parameter 476 can be added to the parameter set 358, 458.

The configuration parameter system 362 examines each independent parameter 470 and secondary parameter 472 in the parameter set 358 to determine if one or more dependent parameters 476 are to be added to the parameter set 356. In one embodiment, the dependent parameter 476 can be selected from a predefined list of dependent parameters 478. Each dependent parameter 476 selected by the configuration parameter system is added to the parameter set 358, 458.

Continuing with FIGS. 1, 3 and 4, the parameter set 458 can be used to generate a compilation of parameters 480, such as the authorization code 14. The compilation of parameters 480 is input to the franking system 311 for configuring the customized computerized system 311, 411, and enabling the selected operating features 312. In one embodiment, the authorization code 14 can be a 20 digit decimal code which is generated using the parameter set 358, 458, which can include the independent, secondary, and dependent parameters in the parameter set 358, 458, and the identifying features of the franking system 11. In another embodiment, the authorization code 14 can be generated manually from the parameters in the parameter set 358, and the identifying features of the franking system 11.

The authorization code 14 may be encrypted or otherwise protected so that it would be difficult to determine from the authorization code 14 which operating features 12 are enabled by particular sections of the authorization code 14. The encryption can prevent unauthorized persons from generating and entering authorization codes which would enable franking system operating features for which the franking system representative has not been compensated. Any suitable encryption and/or signing algorithm can be used in order to create an authorization number. The type of algorithm depends on the security requirements of the customer and the resources available in the franking system for decoding an encrypted and/or signed algorithm. In another embodiment, protecting the authorization code 14 can include generating the authorization code as a binary number. The binary number can be converted to a decimal number, which can be incorporated in the authorization code.

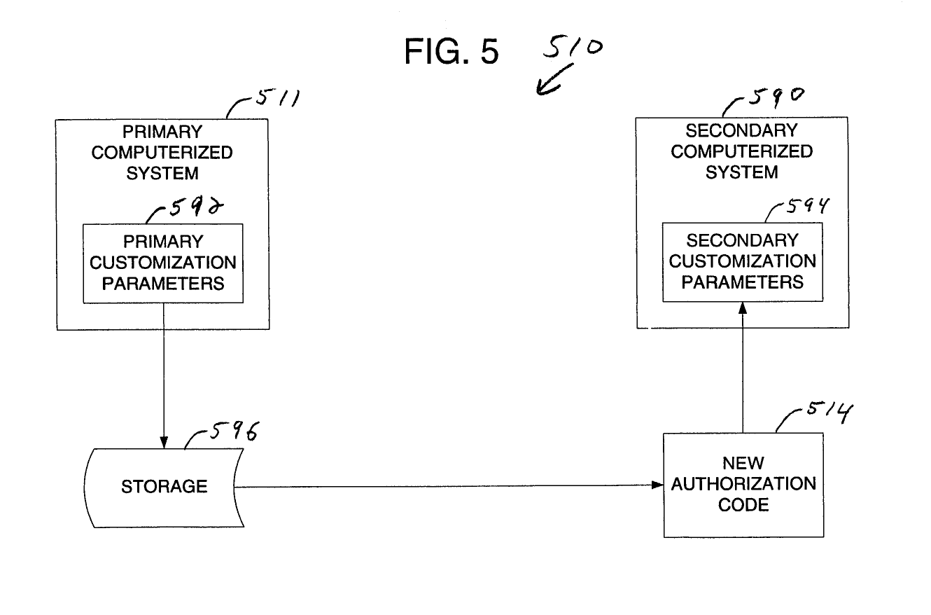

Referring to FIG. 5, a method 510 for duplicating a configuration of a primary franking system 511 in a secondary franking system 590 can easily be accomplished by storing the primary customization parameters 592 in a storage device 596, generating a new authorization code 514 based on the primary customization parameters 592, and inputting the new authorization code 514 into the secondary franking system 590. In one embodiment, the primary franking system's authorization code 14 can be decoded into a parameter set 458 to generate the secondary customization parameters 594, which enable the same operating features in the secondary franking system 590 as in the primary franking system 511. In another embodiment, the primary customization parameters 592 can be the parameters in the parameter set 358 which generated the authorization code 14 for the primary computerized system 511. In another embodiment, the primary customization parameters 592 which are stored can be the authorization code 14 representing the enabled operating features 12 of the primary computerized system 511.

Continuing with FIG. 5, in one embodiment, the storage device 596 can be associated with the production system 310 which generated the authorization code 14 for the primary computerized system 511, and can include the associated parameter set 358. In another embodiment, the storage device is any device, such as a CD, floppy disk, printout or even piece of paper, with the listing of enabled operating features 12 of the primary computerized system 511. In one embodiment, each computerized system 511 has at least one unique identifying feature which is used to link the computerized system 511 with the authorization code 14, so that only one authorization code is valid to enable the operating features of the computerized system 511. In another embodiment, a combination of non-unique identifying features of the franking system 11 can be combined as a unique identifying feature.

Continuing to refer to FIG. 5, the new authorization code 514 for the secondary computerized system 590 can be generated by using a unique identifying feature associated with the secondary computerized system 590, rather than the unique identifying feature associated with the first computerized system 511. Only an authorization code 514 which includes the unique identifying feature associated with the secondary computerized system 590 will be able to enable the operating features of the secondary computerized system 590.

Referring to FIG. 1, an additional operating feature 12 of franking system 11 can enabled merely by entering a new authorization code 14. This updating of the franking system 11 can be done at the customer's site. The franking system 11 does not have leave the customer site to be updated, and a franking system representative does not have to be present at the customer's site to perform the update.

Referring to FIG. 4, in one embodiment, the franking system 11 is to be updated by enabling a currently disabled operating feature 24. The parameter set 458 used to enable the franking system 11 is updated with the new selected operating feature 12 by adding an independent parameter 470 representing the disabled operating feature 12. The secondary parameters 472 and dependent parameters 476 are selected based on the updated parameter set 458. The new authorization code 14 is generated based on the updated parameter set, and is entered into the franking system 11. The disabled operating feature 24 is then enabled, and usable in the franking system.

The new authorization code 14 can be generated by transmitting the selected operating features 12 to a franking system representative, such as the franking system manufacturer. The franking system representative can use the selected operating features 12 to generate the new authorization code 14. There is no need to transfer a physical medium to and from the customer, as the selected operating features and franking system identifying features can be transmitted electronically, and the new authorization code 14 can be transmitted to the customer site electronically. The new authorization code 14 can be transmitted by the franking system representative to the customer site and entered into the franking system 11, such as by typing on the franking module keyboard. In one embodiment, a communications system, such as the internet, can be used for transmitting the selected operating features and franking system identifying features to the franking system representative and receiving the authorization code 14 at the customer site. In another embodiment, the authorization code 14 can be included on a chip card, which can be used to enter the authorization code into the franking system 11. In a further embodiment, the authorization code 14 could be printed on an invoice for the customer.

In another embodiment, a currently enabled operating feature 32 can be selected to be disabled. The independent parameter 470 representing the enabled operating feature 32 can be removed from the franking system's parameter set 458. The secondary parameters 472 and dependent parameters 476 are selected based on the updated parameter set 458. The new authorization code 14 is generated based on the updated parameter set 458, and is entered into the franking system 11. The enabled operating feature 32 is then disabled, and unavailable for use in the franking system 11.

In a further embodiment, the operating features 12 of the current franking system 11 can be saved. When an update is to be accomplished, new operating features 30 are added to the saved operating features, and operating features to be removed 24 are removed from the saved operating features. The updated saved operating features can be the parameter set 458 of independent parameters 470. The parameter set 458 can be used, along with the associated secondary parameters 472 and dependent parameters 476, to generate a new authorization code 14, which can be entered into the franking system 11.

Referring to FIG. 5, in one embodiment, the saved operating features 12 can be saved in a storage device 596. In another embodiment, the saved operating features can be listed on a document. In addition, the updating process can include the generation of a revenue request, such as an invoice, for the cost of the additional operating feature 12 which is enabled by the franking system representative. The revenue request can be automatically generated by the updating of the authorization code for the same franking system 11. The generated revenue request can be transmitted to the customer. The automatic generation of the revenue request helps ensure that the franking system representative is compensated for the inclusion of any additional operating features in the franking system 11.

As shown in FIG. 1, the franking system 11 includes operating features 12 which are enabled and disabled, including hardware and software operating features. Since the franking system can have disabled operating features which can be easily enabled by the franking system representative, a smaller number of versions of the franking system 11 can be manufactured, tested and stocked, which greatly reduces costs in contrast with manufacturing, testing and stocking versions of the franking system 11 customized for each customer's requirements. The franking system 11 can include software necessary for enabling all included operating features, including the enabled and disabled operating features. Some of the software can be enabled, while other software is disabled, as shown in FIG. 1.

In addition, all franking system operating features 12 can be already integrated with the all other franking system 11 operating features 12 and, tested before release by the franking system manufacturer. Since additional software does not have to be added to the franking system 11, the testing of the installed or upgraded operating features during installation or upgrade is unnecessary, which reduces the cost of franking system 11 installation or franking system 11 upgrades.

Furthermore, the franking system 11 can be configured, and the desired operating features 12 selected, merely by entering the authorization code 14. Representative(s) of the franking system 11 do not have to be present at the customer's location to perform the installation or upgrade of the franking system 11, since in one embodiment, the authorization code 14 can be entered into the franking system 11 from a remote location via a computer network such as the internet, again reducing costs. Additional hardware or software is not required for installing or updating the franking system 11, and a franking system representative does not have to be present at the customer's location to perform the installation or upgrade of the franking system 11. Moreover, the generation of the authorization code 14 can also generate a revenue request from the franking system representative to the customer, thereby making sure that the franking system representative is compensated for the inclusion of any additional operating features in the franking system 11. In addition, the entry of the authorization code 14 disables the operation of unauthorized operating features and devices which may have been added to the franking system 11. The disabling can preserve revenue for the franking system representative, prevent interference with incompatible devices, and ensure the quality of the franking system operating features 12. Referring to FIGS. 1 and 5, the duplication of the operating features 12 of a primary franking system 511 in a secondary franking system 590 can be accomplished simply by generating another authorization code 14 based on the operating features of the primary franking system 511 and the identifying feature of the secondary franking system 590, and entering the authorization code 14 into the secondary franking system 590.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for customizing a computerized system having a plurality of operating features, including the steps of:
selecting at least one independent parameter from a predefined list of independent parameters for selecting at least one of the operating features of the customized computerized system, and storing the selected independent parameter in a parameter set;
selecting at least one secondary parameter from a predefined list of secondary parameters for enabling the at least one of the selected operating features, wherein the secondary parameters are associated with the at least one independent parameter, and storing the at least one selected secondary parameter in the parameter set;
determining at least one dependent parameter for configuring the computerized system, wherein the dependent parameter is generated from a predefined list of dependent parameters in accordance with the parameter set, and adding the dependent parameter to the parameter set;
installing a compilation of parameters in the customized computerized system, the compilation of parameters generated from the parameter set, wherein the compilation of parameters enable the selected operating features of the customized computerized system.

2. The method of claim 1, wherein the step of installing the compilation of parameters in the customized computerized system includes the step of storing the compilation of parameters in a chip card for installing in the customized computerized system.

3. The method of claim 1, wherein the step of installing the compilation of parameters in the customized computerized system includes the steps of:
transmitting the parameter set to a third party;
receiving the compilation of parameters from the third party, wherein the compilation of parameters is an authorization code; and
entering the authorization code in the computerized system to enable the selected operating features.

4. The method of claim 3, wherein the step of transmitting the parameter set to the third party includes
the step of transmitting the parameter set via the internet, and wherein
the step of receiving an authorization code from the third party includes receiving the authorization code via the internet.

5. The method of claim 1, wherein the step of selecting at least one secondary parameter, further includes the steps of:
selecting carrier parameters for defining at least one carrier operating feature; and
selecting default parameters for defining the independent parameters which are required for enabling operating features of the customized computerized system and have not been selected.

6. The method of claim 1, wherein the step of selecting at least one dependent parameter includes the steps of:
determining a unique serial number for the at least one of the selected operating features of the customized computerized system, and
adding the unique serial number to the parameter set.

7. The method of claim 1, wherein the customized computerized system is a franking system.

8. A method for customizing a franking system, comprising the steps of:
providing a franking system having a plurality of disabled operating features;
selecting at least one of the plurality of disabled operating features from the plurality of disabled operating features for enabling for use in the franking system;
storing the at least one of the selected disabled operating features in a parameter set;
generating an authorization code based on the parameter set for enabling the selected disabled operating features of the franking system; and
entering the authorization code into the franking system wherein each of the selected disabled operating features are enabled.

9. The method of claim 8, wherein in the step of providing the franking system having at least one of a plurality of disabled operating features, operating features can include a dynamic scale or a static scale.

10. The method of claim 8, wherein in the step of providing the franking system having a plurality of disabled operating features, one of the operating features is a type of accounting system.

11. The method of claim 8, wherein the step of generating an authorization code based on the parameter set for enabling the selected operating features of the franking system includes the steps of:
transmitting the parameter set to a third party; and
receiving the authorization code from the third party.

12. The method of claim 11, wherein in the step of transmitting the parameter set to a third party, the third party is a franking system manufacturer.

13. The method of claim 8, wherein the step of generating the authorization code includes the steps of:
providing the parameter set to a third party via an internet system; and
receiving the authorization code from the third party via the internet system.

14. The method of claim 8, wherein for each of the selected disabled operating features in the parameter set, determining if an additional operating feature is necessary for operation of the selected operating features, and if so, including the additional operating feature in the parameter set.

15. The method of claim 14, wherein the step of determining if an additional operating feature is necessary for operation of the selected operating features includes determining a postal carrier for which the franking system will be used.

16. The method of claim 8, further including the step of determining a unique serial number for the at least one of the selected disabled operating features and the additional operating feature for each of the selected disabled operating features, and adding the unique serial number to the parameter set.

17. The method of claim 8, wherein in the step of entering the authorization code into the franking system, the entry of the authorization code determines the enabling and disabling of a unique group of operating features, which are not the same as the operating features which are enabled and disabled by the entry of another authorization code.

18. The method of claim 8, wherein in the step of entering the authorization code into the franking system, the authorization code is received from a data carrier into the franking system.

19. The method of claim 8, wherein in the step of entering the authorization code into the franking system, the authorization code is entered into the franking system from a franking system input device.

20. The method of claim 8, wherein in the step of providing the franking system having a plurality of disabled operating features, one of the operating features is a letter flow speed.

21. The method of claim 8, wherein in the step of providing the franking system having a plurality of disabled operating features, one of the operating features is a rate package.

22. The method of claim 8, wherein in the step of providing the franking system having a plurality of disabled operating features, one of the operating features static weighing for a dynamic scale.

23. The method of claim 8, wherein the step of entering an authorization code into the franking system disables the operation of unauthorized operating features and unauthorized devices connected to the franking system.

24. A production system for generating a customized computerized system having a plurality of flexible operating features, comprising:
a customer sheet system for recording the selection of an operating feature from a list of predefined operating features, and for generating at least one independent parameter;
a parameter set for storing the at least one independent parameter;
a manufacturer parameter system for providing at least one secondary parameter associated with the at least one independent parameter for implementing the selected operating feature, and for storing the at least one secondary parameter in the parameter set;
a configuration parameter system for generating at least one dependent parameter based on the independent parameter and the secondary parameter for configuring the customized computerized system, and for adding the at least one dependent parameter to the parameter set; and
an input device for entering a compilation of parameters in the customized computerized system for configuring the customized computerized system, the compilation of parameters generated from the parameter set by the configuration parameter system.

25. The production system of claim 24, wherein the secondary parameters include carrier parameters for defining at least one carrier operating feature, current component parameters for defining a group of components for assembling the customized computerized system, and default parameters for defining independent parameters which are required and have not been selected.

26. The production system of claim 25, wherein the input device is at least one of a keyboard, an audio input device, a video input device, a CD-ROM reader, a chip card reader, or a computer network.

27. The production system of claim 24, wherein the compilation of parameters is an authorization code.

28. The production system of claim 24, wherein the customized computerized system is a franking system.

29. A method of exchanging a primary computerized system having enabled and disabled operating features for a secondary computerized system having identical enabled and disabled operating features, comprising the steps of:
accessing customization parameters of the primary computerized system which define the enabled and the disabled operating features of the primary computerized system;
storing the customization parameters for preserving the enabled and disabled operating features of the primary computerized system; and
installing the customization parameters in a secondary computerized system for duplicating the enabled and disabled operating features of the primary computerized system in the secondary computerized system by loading the stored customization parameters into the secondary computerized system.

30. The method of claim 29, wherein the primary computerized system is a franking system and the secondary computerized system is another franking system.

31. A method for enabling an additional operating feature of a franking system, comprising the steps of:
providing a franking system having at least one disabled operating feature, and at least one operating feature which is enabled and available for use;
selecting the new operating feature for adding to the franking system from the at least one disabled operating feature;
generating an authorization code associated with the enabled operating features and the selected disabled operating feature for enabling the selected disabled operating feature and the enabled operating features; and
entering the authorization code into the franking system for enabling the selected disabled operating feature and the enabled operating features.

32. The method of claim 31, wherein the step of generating an authorization code includes the step of generating a revenue request for the selected disabled operating feature.

33. The method of claim 31, wherein the step of generating an authorization code includes the steps of:
transmitting the enabled operating features and the selected disabled operating feature to a third party; and
receiving the authorization code from the third party.

34. The method of claim 33, wherein in the step of transmitting the enabled operating features and the selected disabled operating feature to the third party, the third party is a franking system manufacturer.

35. The method of claim 33, wherein the step of transmitting the enabled operating features and the selected disabled operating feature to the third party includes the step of transmitting via the internet to the third party.

36. The method of claim 33, wherein the step of receiving the authorization code from the third party includes the step of receiving the authorization code via an internet.

37. The method of claim 31, wherein the step of entering the authorization code in to the franking system further includes the steps of:
creating an update chip card including the authorization code for enabling the disabled operating feature for use; and
inserting the update chip card into the franking system and loading the authorization code from the chip card into the franking system.

38. The method of claim 31, wherein the step of entering the authorization code into the franking system disables the operation of unauthorized operating features and devices connected to the franking system.
